(19) United States
(12) Patent Application Publication
(10) Pub. No.: US 2025/0097813 A1
(43) Pub. Date: Mar. 20, 2025

(54) METHOD AND APPARATUS FOR TRANSMITTING USER DATA BASED ON MULTIPLE ACCESS IN WIRELESS COMMUNICATION SYSTEM

(71) Applicant: Samsung Electronics Co., Ltd., Gyeonggi-do (KR)

(72) Inventor: Kisuk KWEON, Gyeonggi-do (KR)

(21) Appl. No.: 18/829,821

(22) Filed: Sep. 10, 2024

(30) Foreign Application Priority Data
Sep. 15, 2023 (KR) 10-2023-0123288

(51) Int. Cl. H04W 40/02; H04W 40/24; H04W 48/16; H04W 60/04

(52) U.S. Cl. CPC H04W 40/02; H04W 40/248; H04W 48/16; H04W 60/04

(57) ABSTRACT

The disclosure relates to a 5G or 6G communication system for supporting a higher data transmission rate. Disclosed is a by a policy control function (PCF) entity in a wireless communication system, including receiving, from a user equipment (UE), a registration request including radio capability information about the UE through an access and mobility management function (AMF) entity, updating UE route selection policy (URSP) rule information based on the radio capability information about the UE, and transmitting, to the UE, the updated URSP rule information through the AMF entity.

### CROSS-REFERENCE TO RELATED APPLICATION(S)

This application is based on and claims priority under 35 U.S.C. § 119 to Korean Patent Application No. 10-2023-0123288, which was filed in the Korean Intellectual Property Office on Sep. 15, 2023, the entire content of which is incorporated herein by reference.

### BACKGROUND

### 1. Field

The disclosure relates generally to a wireless communication system and, more particularly, to a method and apparatus for selecting an access network used to transmit a specific service data flow in an environment where user data may be transmitted using various radio access networks.

### 2. Description of Related Art

Fifth generation (5G) mobile communication technology defines a wide frequency band to enable fast transmission speed and new services and may be implemented in frequencies below 6 gigahertz (GHz), such as 3.5 GHz, as well as in ultra-high frequency bands above 6 GHz, such as 28 GHz and 39 GHz referred to as millimeter wave (mm Wave) bands. Sixth generation (6G) mobile communication technology, which is referred to as a beyond 5G system, is considered to be implemented in terahertz (THz) bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive multiple input multiple output (MIMO) for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as a low density parity check (LDPC) code for massive data transmission and polar code for high-reliable transmission of control information, layer 2 (L2) pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the voice over new radio (VoNR), new radio unlicensed (NR-U) aiming at the system operation matching various regulatory requirements, NR user equipment (UE) power saving, a non-terrestrial network (NTN), which is direct communication between a UE and a satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access channel (2-step RACH) for NR to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, a soaring number of devices are expected to be connected to communication networks so that reinforcement of the function and performance of the 5G mobile communication system and integrated operation of connected devices are expected to be needed. To this end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of THz band signals, AI-based communication technology for realizing system optimization by embedding end-to-end AI supporting function and using satellite and AI from the design stage, and next-generation distributed computing technology for implementing services with complexity beyond the limit of the UE operation capability by way of ultrahigh performance communication and computing resources.

### SUMMARY

The disclosure has been made to address at least the above-mentioned problems and/or disadvantages and to provide at least the advantages described below.

Accordingly, an aspect of the disclosure is to provide a method and apparatus for effectively providing services in a wireless communication system.

In accordance with an aspect of the disclosure, a method by a policy control function (PCF) entity in a wireless communication system includes receiving, from a UE, a registration request including radio capability information about the UE through an access and mobility management function (AMF) entity, updating UE route selection policy (URSP) rule information based on the radio capability information about the UE, and transmitting, to the UE, the updated URSP rule information through the AMF entity.

In accordance with an aspect of the disclosure, a method by a UE in a wireless communication system includes transmitting, to a PCF entity, a registration request including radio capability information about the UE through an AMF entity, and receiving, from the PCF entity, updated URSP rule information through the AMF entity, wherein the radio capability information about the UE is used for the updated URSP rule information.

In accordance with an aspect of the disclosure, a PCF entity in a wireless communication system includes a transceiver, and at least one processor. The at least one processor is configured to receive, from a UE, a registration request including radio capability information about the UE through an AMF entity, update URSP rule information based on the radio capability information about the UE, and transmit, to the UE, the updated URSP rule information through the AMF entity.

In accordance with an aspect of the disclosure, a UE in a wireless communication system includes a transceiver, and at least one processor. The at least one processor is configured to transmit, to a PCF, a registration request including radio capability information about the UE through an AMF entity, and receive, from the PCF entity, updated URSP rule information through the AMF entity, wherein the radio capability information about the UE is used for the updated URSP rule information.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a structure of a 5G network according to an embodiment;

FIG. 2 illustrates a structure of a 5G network for supporting an access traffic steering, switching, splitting (ATSSS) service according to an embodiment;

FIG. 3 illustrates a structure of a UE including a function for use of an ATSSS service according to an embodiment;

FIG. 4 illustrates an example of an extended ATSSS service according to an embodiment;

FIG. 5 illustrates a method for selecting a route for transmitting a service data flow generated in a UE to a DN according to an embodiment;

FIG. 6 illustrates an example of a wireless modem and a subscriber identity module (SIM) type according to an embodiment;

FIGS. 7A, 7B, and 7C illustrate a procedure in which a UE registers with a network according to an embodiment;

FIG. 8 illustrates a UE configuration update procedure according to an embodiment;

FIG. 9 illustrates a method of a PCF according to an embodiment;

FIG. 10 illustrates a method of a UE according to an embodiment;

FIG. 11 illustrates a configuration of a base station or a network entity according to an embodiment; and

FIG. 12 illustrates a configuration of a UE according to an embodiment.

### DETAILED DESCRIPTION

Hereinafter, embodiments of the disclosure will be described in detail with reference to the accompanying drawings. A detailed description of known functions or configurations incorporated herein will be omitted for the sake of clarity and conciseness.

For the same reasons, some elements may be exaggerated or schematically shown. The size of each element does not necessarily reflect the actual size of the element. The same reference numeral may be used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto.

Each block may represent a module, segment, or part of a code including one or more executable instructions for executing a specified logical function(s). In some embodiments, the functions in the blocks may occur in different orders. For example, two blocks that are consecutively shown may be performed substantially simultaneously or in reverse order depending on corresponding functions.

The components included in the disclosure are represented in singular or plural forms depending on the embodiment. However, the singular or plural forms are selected to be adequate for contexts suggested for ease of description, and the disclosure is not limited thereto. As used herein, the singular forms “a,” “an,” and “the” are intended to include the plural forms as well, unless the context clearly indicates otherwise.

As used herein, the term unit indicates a software element or a hardware element such as a field-programmable gate array (FPGA) or an application specific integrated circuit (ASIC). A unit plays a certain role. However, the term unit is not limited as meaning a software or hardware element. A unit may be configured in a storage medium that may be addressed or may be configured to reproduce one or more processors. Accordingly, as an example, a unit includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the units may be combined into smaller numbers of components and units or further separated into additional components and units. The components and units may be implemented to execute one or more CPUs in a device or secure multimedia card.

Hereinafter, the base station may be an entity allocating a resource to the UE and may be at least one of a NodeB, Node B, base station (BS), eNode B (eNB), gNode B (gNB), radio access unit, base station controller, or node on network. The UE may include a mobile station (MS), cellular phone, smartphone, computer, or multimedia system capable of performing communication functions. Embodiments of the disclosure may also apply to other communication systems with similar technical background and may be modified so as not to significantly depart from the scope of the disclosure.

As used herein, terms for identifying access nodes and denoting network entities or network functions (NFs), messages, inter-network entity interfaces, and various pieces of identification information are provided as an example for ease of description. Thus, the disclosure is not limited to the terms, and the terms may be replaced with other terms denoting objects with equivalent technical meanings.

For ease of description, some of the terms and names defined in the 3rd generation partnership project long term evolution (3GPP LTE) standards may be used herein. However, the disclosure is not limited by such terms and names and may be likewise applicable to systems conforming to other standards.

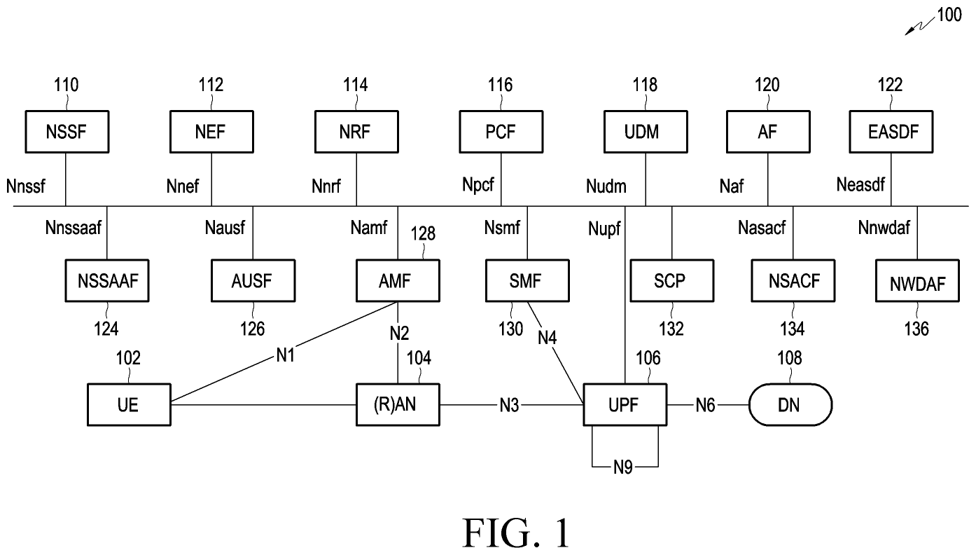

FIG. 1 illustrates a structure of a 5G network 100 according to an embodiment.

Referring to FIG. 1, the radio access network ((R)AN) 104 indicates an entity that allocates a radio resource to a UE and may be at least one of an eNode B, Node B, base station (BS), next generation radio access network (NG-RAN), 5G-AN, radio access unit, base station controller, or a node on network.

The UE 102 may be a next generation (NG) UE, mobile station (MS), cellular phone, smartphone, computer, or multimedia system capable of performing communication functions. Although embodiments are described below in connection with a 5G system, the embodiments may also be applicable to other communication systems with a similar technical background.

As evolving from a fourth generation (4G) system to a 5G system, the wireless communication system defines a new core network, e.g., NextGen core (NG Core) or 5G core network (5GC), in which the legacy network entities (NEs) all are virtualized into NFs. The NF refers to a network entity, network component, or network resource.

The 5GC may include NFs as illustrated in FIG. 1 or may include fewer or more NFs than those shown in FIG. 1.

The AMF 128 may be an NF that manages the access and mobility of the UE 102. As an example, the AMF 128 may perform such NFs as registration, connection, reachability, mobility management, access identification, authentication, and mobility event generation.

The session management function (SMF) 130 may be an NF that manages packet data network (PDN) connection provided to the UE 102. The PDN connection may be referred to as a packet data unit (PDU) session. For example, the SMF 130 may perform such NFs as SMFs of establishing, modifying, or releasing a session and maintaining a tunnel between the UPF 106 and the RAN 104 necessary therefor, the functions of allocating and managing an Internet protocol (IP) address of the UE 102, selection and control of the user plane, control of traffic processing on the UPF 106, and billing data gathering control.

The PCF 116 may be an NF that applies a service policy, billing policy, and PDU session policy of the mobile communication service provider to the UE 102.

The unified data management (UDM) 118 may store information about the subscriber. For example, the UDM 118 may perform functions, such as generating authentication information for 3GPP security, processing the user identifier (ID), managing a list of NFs supporting the UE 102, and managing subscription information.

The application function (AF) 120 may be a control unit function within or outside the core network that may provide application services to subscribers.

The edge application server (EAS) discovery function (EASDF) 122 may operate as a domain name system (DNS) resolver to receive and respond to DNS queries from the UE 102, and may further report DNS query receipt information to the SMF 130 according to behavioral instructions defined by the SMF 130. The network slice-specific authentication and authorization (NSSAA) function 124 may offer service to the AMF 128 via the Nnssaaf service based interface. The AMF 128 may make use of the NSSAAF service when it needs to invoke network slice-specific authentication and authorization for a specific UE and a specific S-NSSAI.

The service communication proxy (SCP) 132 may be a HTTP/2-based network function enabling dynamic scaling and management of communication and services in the 5G network.

The network slice admission control (NSAC) function (NSACF) 134 may monitor and control the number of registered UEs 102 and established PDU sessions per network slice and feed the information to the AF 120 for analysis and further processing.

The network data analytics function (NWDAF) 136 may streamline the way core network data is produced and consumed, as well as generate insights and take actions to enhance end-user experience.

The network exposure function (NEF) 112 may provide information about the UE 102 to a server outside the 5G network. The NEF 112 may also provide information necessary for a service to the 5G network and store the information in a unified data depository (UDR).

The user plane function (UPF) 106 may serve as a gateway for transmitting a PDU to a data network (DN) 108. More specifically, the UPF 106 may serve to process data to be able to transfer the data transmitted from the UE 102 to an external network or transfer the data introduced from the external network to the UE 102. For example, the UPF 106 may perform NFs, such as acting as an anchor between radio access technologies (RATs), packet routing and forwarding, packet inspection, application of user plane policy, creating a traffic usage report, or buffering.

The network repository function (NRF) 114 may perform a function of discovering an NF.

The authentication server function (AUSF) 126 may perform authentication on the UE 102 in a 3GPP access network and a non-3GPP access network.

The network slice selection function (NSSF) 110 may perform a function of selecting a network slice instance provided to the UE 102.

The DN 108 may be a DN through which the UE 102 transmits and receives data to use a service of the network operator or a 3rd party service.

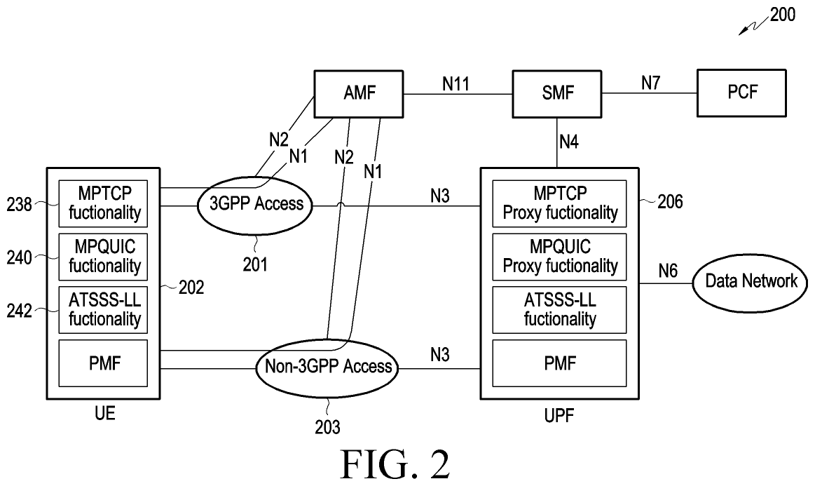

FIG. 2 illustrates a structure 200 of a 5G network for supporting an ATSSS service according to an embodiment.

Referring to FIG. 2, the UE 202 may transmit user data to the network using two or more (R)ANs. In this case, the (R)AN used by the UE 202 may be divided into an access type and a RAT type. Access type is divided into 3GPP access 201 and non-3GPP access 203 network types. The non-3GPP access 203 may include all wireless connection networks other than the 3GPP access 201. The wireless local access network (WLAN) is representative non-3GPP access 203. 3GPP access 201 may be classified into several types of RATs including 5G NR, evolved UTRA (E-UTRA), universal terrestrial radio access (UTRA), or other 3GPP wireless connection networks.

The architecture reference model illustrated in FIG. 2 applies to an ATSSS technology defined in the relevant 3GPP standard.

The network may provide a multi-access connectivity service to the UE 202 using 3GPP access 201 and non-3GPP access 203 networks. To that end, the UE 202 may generate a multi-access PDU session (MA PDU session) including two independent N3/N9 tunnels. The UE 202 may perform traffic steering (a scheme of selecting one of the two wireless connection networks and transmitting service data flow data), traffic switching (a scheme of switching to another wireless connection network and transmitting the service data flow data being transmitted using one wireless connection network), and traffic splitting (a scheme of splitting data of one service data flow and transmitting the data simultaneously using the two wireless connection networks) operations, based on the ATSSS rule, using the MA PDU session.

In order for the UE 202 and the UPF 206 to perform steering, switching, and splitting of service data flow data using the MA PDU session, the UE 202 should include at least one functionality of multipath transmission control protocol (TCP) (MPTCP) functionality 238, multipath quick user datagram protocol (UDP) internet connections (QUIC) (MPQUIC) functionality 240, or ATSSS low-layer (ATSSS-LL) functionality 242, and the UPF 206 should include at least one of the MPTCP proxy functionality 238, MPQUIC proxy functionality 240, or ATSSS-LL functionality 242.

The above-mentioned functions may perform the function of splitting the data of one service data flow into two tunnels, i.e., data of two paths, and simultaneously transmitting them, and merging the data simultaneously transmitted using the two paths into one data flow. Through the data transmission scheme using two paths, the UE 202 may expect an enhanced data throughput.

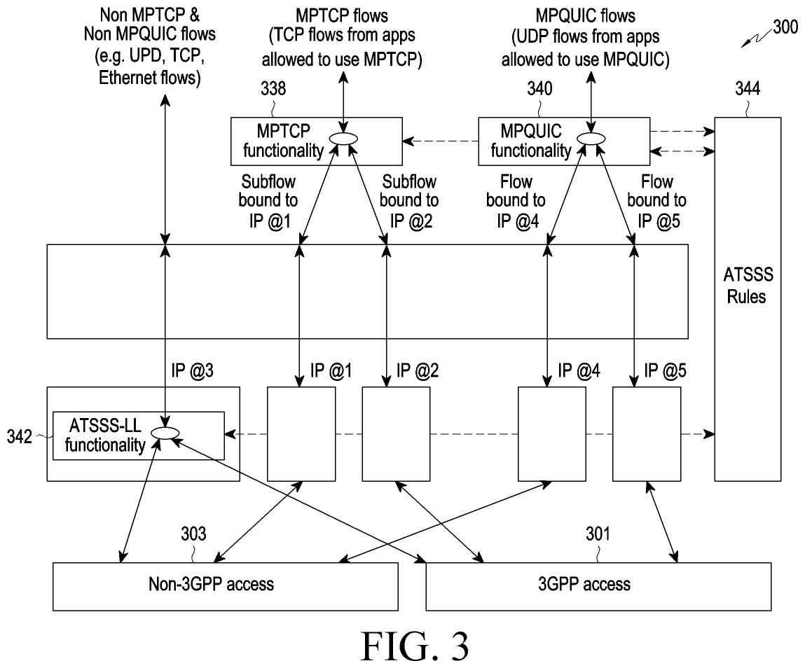

FIG. 3 illustrates a structure 300 of a UE including a function for use of an ATSSS service according to an embodiment.

Referring to FIG. 3, to use the ATSSS service, the UE should include at least one of a multipath TCP (MPTCP) functionality 338, multipath QUIC (MPQUIC) functionality 340, or ATSSS low-layer (ATSSS-LL) functionality 342. The service data flow using the TCP may use the MPTCP functionality 338, and the service data flow using the UDP may use the MPQUIC functionality 340.

All service data flows using the TCP, UDP, or Ethernet protocol may use the ATSSS-LL functionality 342.

To provide the multi-access connectivity service to the UE, each functionality may split one service data flow into two subflows IP @1, IP @2 and simultaneously transmit to the network using two wireless connection networks (non-3GPP access 303 and 3GPP access 301). Individual IP addresses are assigned to the respective subflows IP @1, IP @2 of the MPTCP functionality 338 and the flows IP @4, IP @5 of the MPQUIC functionality 340. In the case of the ATSSS-LL functionality 342, data is transmitted to two wireless connection networks using one IP address.

Functions provided by the ATSSS service for each service data flow are determined by the ATSSS rules 344. The functions provided by the ATSSS service are traffic steering (a scheme of selecting one of the two wireless connection networks and transmitting service data flow data), traffic switching (a scheme of switching to another wireless connection network and transmitting the service data flow data being transmitted using one wireless connection network), and traffic splitting (a scheme of splitting data of one service data flow and transmitting the data simultaneously using the two wireless connection networks) operations.

Disclosed herein is a technique for extending a multi-access connectivity service (i.e., an ATSSS service) provided to a UE using one 3GPP access network and one non-3GPP access network. For example, the UE may receive a multi-access connectivity service using two 3GPP access networks, two non-3GPP access networks, or two other mobile network operators.

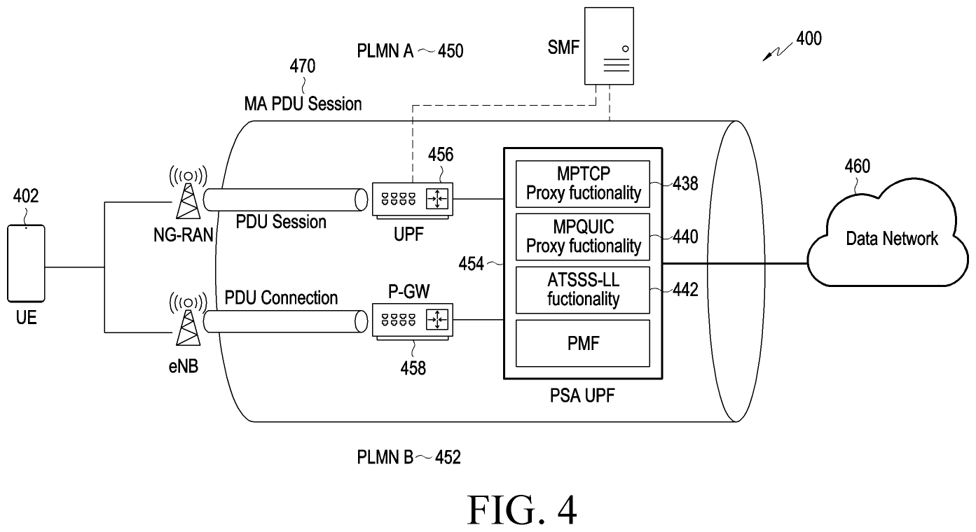

FIG. 4 illustrates an example of an extended ATSSS service 400 according to an embodiment.

Referring to FIG. 4, a UE 402 uses an ATSSS service 400 using two different mobile network operators, public land mobile network (PLMN) A 450 and PLMN B 452. In this case, the UE 402 uses the 3GPP access networks provided by each mobile communication service provider, i.e., a 5G NR network and a 4G evolved universal mobile telecommunications service terrestrial radio access (EUTRA) network. To transmit the data of the service data flow of the UE 402, the 5G network configures a PDU session and the 4G network configures a PDN connection. Data transmitted using each 3GPP access network may be transmitted to a PDU session anchor (PSA) UPF 454 including an ATSSS functionality via a UPF 456 and a PDN gateway (P-GW) 458, respectively. The PSA UPF 454 may reassemble the split data into one service data flow using the MPTCP 438, MPQUIC 440, or ATSSS-LL 442 functionalities and transmit the reassembled data to the DN 460. In this case, each session in 5G and 4G may be included in one MA PDU session 470.

The extended ATSSS may provide the UE 402 with an enhanced service compared to the conventional ATSSS using one legacy 3GPP access network and one non-3GPP access network using two 3GPP access networks, since the non-3GPP access network mainly transmits data using an unlicensed band and does not provide quality of service (QOS) to enhance transmission services.

In FIG. 4, to provide the UE 402 with an extended ATSSS service based on various wireless network combinations, of the conventional ATSSS service which is provided using only one 3GPP access and one non-3GPP access, it is required to extend the conventional URSP rule. To determine the extended URSP rule for each UE, additional information which is not considered to determine the conventional URSP rule, such as the radio capability of the UE 402 or subscription data information, is required. Accordingly, the disclosure provides a method and apparatus regarding a scheme for determining an extended URSP rule based on an extended URSP rule and the UE's additional information.

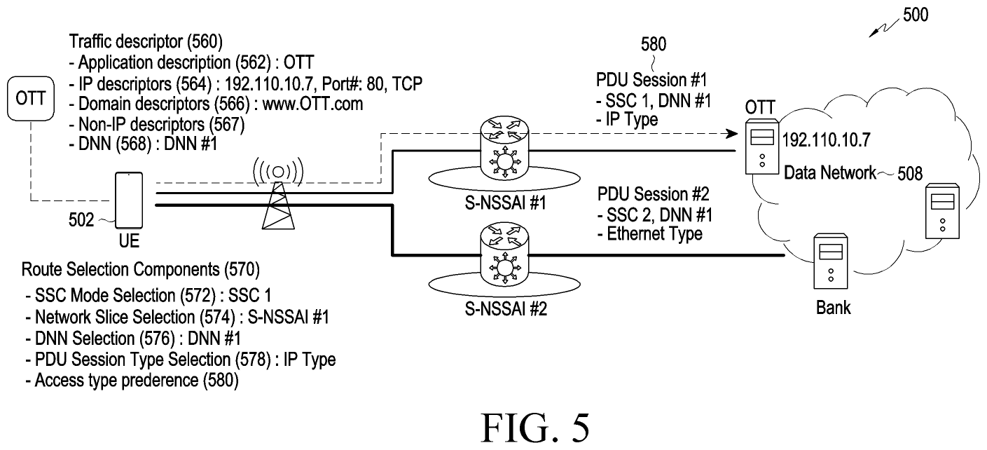

FIG. 5 illustrates a method 500 for selecting a route for transmitting a service data flow generated in a UE to a DN according to an embodiment.

Referring to FIG. 5, in the 5G network, URSP information is used to select a path for transmitting the service data flow generated by the UE 502 to the DN 508. The URSP information includes a prioritized list of URSP rules. Each URSP rule includes at least one of a rule precedence for application priority, a traffic descriptor to divide service data flows, and a list of route selection descriptors to select the route of service data flows divided by traffic descriptors.

The traffic descriptor 560 includes at least one of application descriptors 562, IP descriptors 564, domain descriptors 566, non-IP descriptors 567, and DN name (DNN) 568. Each route selection descriptor includes route selection descriptor precedence, route selection components 570, and route selection validation criteria for the application priority of each route selection descriptor. The route selection components 570 include at least one of SSC mode selection 572, network slice selection 574, DNN selection 576, PDU session type selection 578, and access type preference.

Table 1, Table 2, and Table 3 below show the URSP information, may be based on the relevant 3GPP standard.

More specifically, Table 1 shows the URSP, Table 2 shows the URSP rule, and Table 3 shows the route selection descriptor.

TABLE 1

| | | | PCF | |
|---|---|---|---|---|
| | | | permitted to | |
| Information | | | modify in a | |
| name | Description | Category | URSP | Scope |
| URSP rules | 1 or more URSP | Mandatory | Yes | UE |
| | rules as | | | context |
| | specified in | | | |
| | Table 2. | | | |

TABLE 2

| | | | PCF | |
|---|---|---|---|---|
| | | | permitted to | |
| Information | | | modify in a | |
| name | Description | Category | UE context | Scope |
| Rule | Determines the order the | Mandatory | Yes | UE context |
| Precedence | URSP rule is enforced in | (NOTE 1) | | |
| | the UE. | | | |
| Traffic | This part defines the | Mandatory | | |
| descriptor | Traffic descriptor | (NOTE 3) | | |
| | components for the | | | |
| | URSP rule. | | | |
| Application | It consists of OSId and | Optional | Yes | UE context |
| descriptors | OSAppId(s) (NOTE 2, | | | |
| | NOTE 8). | | | |
| IP | Destination IP 3 tuple(s) | Optional | Yes | UE context |
| descriptors(NOTE 6) | (IP address or IPv6 | | | |
| | network prefix, port | | | |
| | number, protocol ID of | | | |
| | the protocol above IP) | | | |
| | (NOTE 8). | | | |
| Domain | FQDN(s) or a regular | Optional | Yes | UE context |
| descriptors | expression which are | | | |
| | used as a domain name | | | |
| | matching criteria | | | |
| | (NOTE 7, NOTE 8). | | | |
| Non-IP | Descriptor(s) for | Optional | Yes | UE context |
| descriptors(NOTE 6) | destination information | | | |
| | of non-IP traffic | | | |
| | (NOTE 8). | | | |
| Rule | Determines the order the | Mandatory | Yes | UE context |
| Precedence | URSP rule is enforced in | (NOTE 1) | | |
| | the UE. | | | |
| DNN | This is matched against | Optional | Yes | UE context |
| | the DNN information | | | |
| | provided by the | | | |
| | application (NOTE 8). | | | |
| Connection | This is matched against | Optional | Yes | UE context |
| Capabilities | the information provided | | | |
| | by a UE application | | | |
| | when it requests a | | | |
| | network connection with | | | |
| | certain capabilities | | | |
| | (NOTE 4, NOTE 8) or | | | |
| | traffic categories | | | |
| | (NOTE 5). | | | |
| PIN ID | Matched against a PIN | Optional | Yes | UE context |
| | ID for a specific PIN | | | |
| | configured in the PEGC | | | |
| | (NOTE 9). | | | |
| List of | A list of Route Selection | Mandatory | | |
| Route | Descriptors. The | | | |
| Selection | components of a Route | | | |
| Descriptors | Selection Descriptor are | | | |
| | described in table 3. | | | |

TABLE 3

| | | | PCF | |
|---|---|---|---|---|
| | | | permitted to | |
| Information | | | modify in | |
| name | Description | Category | URSP | Scope |
| Route | Determines the order in | Mandatory | Yes | UE context |
| Selection | which the Route | (NOTE 1) | | |
| Descriptor | Selection Descriptors are | | | |
| Precedence | to be applied. | | | |
| Route | This part defines the | Mandatory | | |
| selection | route selection | (NOTE 2) | | |
| components | components | | | |
| SSC Mode | One single value of SSC | Optional | Yes | UE context |
| Selection | mode. (NOTE 5) | | | |
| Network | Either a single value or a | Optional(NOTE 3) | Yes | UE context |
| Slice | list of values of S- | | | |
| Selection | NSSAI(s). | | | |
| DNN | Either a single value or a | Optional | Yes | UE context |
| Selection | list of values of DNN(s). | | | |
| PDU Session | One single value of PDU | Conditional(NOTE 8) | Yes | UE context |
| Type | Session Type | | | |
| Selection | | | | |
| Non- | Indicates if the traffic of | Optional(NOTE 4) | Yes | UE context |
| Seamless | the matching application | | | |
| Offload | is to be offloaded to non- | | | |
| indication | 3GPP access outside of a | | | |
| | PDU Session. | | | |
| ProSe Layer- | Indicates if the traffic of | Optional(NOTE 4) | Yes | UE context |
| 3 UE-to- | the matching application | | | |
| Network | is to be sent via a ProSe | | | |
| Relay | Layer-3 UE-to-Network | | | |
| Offload | Relay outside of a PDU | | | |
| indication | session. | | | |
| ProSe Multi- | Indicates if the traffic of | Optional(NOTE 9) | Yes | UE context |
| path | the matching application | | | |
| Preference | is preferred to be sent via | | | |
| | a PDU Session over the | | | |
| | Uu reference point and a | | | |
| | ProSe Layer-3 UE-to- | | | |
| | Network Relay outside | | | |
| | of a PDU session. | | | |
| Access Type | Indicates the preferred | Optional | Yes | UE context |
| preference | Access Type (3GPP or | | | |
| | non-3GPP or Multi- | | | |
| | Access) when the UE | | | |
| | establishes a PDU | | | |
| | Session for the | | | |
| | matching application. | | | |
| PDU Session | An indication shared by | Optional | Yes | UE context |
| Pair ID | redundant PDU Sessions | | | |
| | as described in | | | |
| | clause 5.33.2.1 of | | | |
| | TS 23.501 [2]. | | | |
| RSN | The RSN as described in | Optional | Yes | UE context |
| | clause 5.33.2.1 of | | | |
| | TS 23.501 [2]. | | | |
| Route | This part defines the | Optional | | |
| Selection | Route Validation Criteria | | | |
| Validation | components | | | |
| Criteria(NOTE 6) | | | | |
| Time | The time window when | Optional | Yes | UE context |
| Window | the matching traffic is | | | |
| | allowed. The RSD is not | | | |
| | considered to be valid if | | | |
| | the current time is not in | | | |
| | the time window. | | | |
| Location | The UE location where | Optional | Yes | UE context |
| Criteria | the matching traffic is | | | |
| | allowed. The RSD rule is | | | |
| | not considered to be | | | |
| | valid if the UE location | | | |
| | does not match the | | | |
| | location criteria. | | | |

In FIG. 5, the service data flows generated by the UE 502 are divided by the traffic descriptor and the paths are selected by the corresponding route selection components. The selection of the path indicates that the UE 502 selects PDU session #1 (580) or PDU session #2 (582). In other words, if there is a PDU session meeting the route selection components value among the existing PDU sessions generated by the UE 502, the newly generated service data flow is transmitted to the DN 508 using the PDU session, and if there is no PDU session meeting the route selection components value among the existing PDU sessions, a new PDU session is generated using the route selection components value and the generated PDU session is used to transmit the service data flow to the DN 508.

The value of the route selection components is as follows.
SSC Mode Selection: SSC 1
Network Slice Selection: S-NSSAI #1
DNN Selection: DNN #1
PDU Session Type Selection: IP Type

Accordingly, since PDU session #1 (580) meets it among the existing PDU sessions, the path of the newly generated service data flow is selected as PDU session #1 (580), and data is transmitted to the DN 508 using the path.

In the case of the access type preference item among the route selection components of the URSP rule, the selectable type is one of 3GPP access, non-3GPP access, or multi-access. This determines whether to transmit the service data flow using the 3GPP access or non-3GPP access wireless network using the normal PDU session or by simultaneously using the 3GPP access wireless network and the non-3GPP access wireless network using the MA PDU session. However, in the extended ATSSS supporting various wireless networks, access type selection information for more various wireless networks is required. To that end, the network is required to receive information about various wireless network use capabilities of the UE.

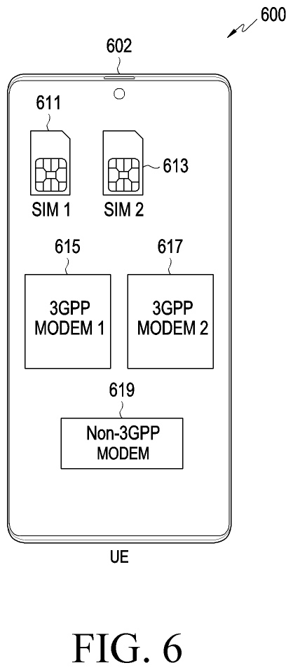

FIG. 6 illustrates an example of a wireless modem and a SIM type according to an embodiment.

Referring to FIG. 6, the UE 602 may include one or more SIMs the UE 602 and may be classified into a dual SIM dual active (DSDA), a dual SIM dual standby (DSDS), a dual SIM single standby (DSSS), a single SIM dual active (SSDA), or a single SIM dual standby (SSDS).

The DSDA type includes two SIMs 611, 613 and two 3GPP modems 615, 617. A DSDA UE may simultaneously access the networks of subscribed different mobile network operators using two SIMs and simultaneously transmit/receive data through the networks of the two mobile network operators using two 3GPP modems.

The DSDS type includes two SIMs 611, 613 and one 3GPP modem 615, 617. The DSDS UE may simultaneously access the networks of subscribed different mobile network operators using the two SIMs 611, 613. However, since it has only one 3GPP modem, the UE 602 may transmit/receive data by simultaneously using the two accessed mobile network operator networks. In this case, the modem is automatically connected to the network of the mobile network operator that has data to be transmitted/received, of the two mobile network operator networks.

The DSSS type includes two SIMs 611, 613 and one 3GPP modem 615, 617. The difference between the DSSS UE and the DSDS UE is that the two subscribed mobile network operator networks should be manually changed. In other words, in the DSSS type, if data is to be transmitted/received using the other mobile network operator network while data is being transmitted/received using one mobile network operator network, the user is required to manually change the SIM to use the other mobile network operator network.

The SSDA type includes one SIM and two 3GPP modems 615, 617. Since the SSDA UE has only one SIM, it may access one subscribed mobile network operator network. However, since it has two modems, data may be transmitted/received using two mobile network operator networks. In this case, the UE 602 may access the subscribed mobile network operator network and transmit/receive data by simultaneously using both the mobile network operator wireless networks by additionally using a mobile network operator network in which roaming or equivalent PLMN is negotiated with the home PLMN (HPLMN).

The SSDS type includes one SIM and one 3GPP modem, as in a commonly used UE. Such a UE may transmit/receive data using one 3GPP access network and one non-3GPP access network as in the conventional ATSSS scheme.

All of the above-mentioned types of UEs mostly include a non-3GPP modem 619. Accordingly, it is possible to transmit/receive data not only using two 3GPP access wireless networks as in the above-described case, but also simultaneously using the 3GPP access network and the non-3GPP access network as conventional. For the non-3GPP access network 619, it is possible to use a non-3GPP access network 619 (e.g., Wi-Fi wireless router) personally installed by the user, as well as the non-3GPP access network 619 of another mobile network operator, or the non-3GPP access network 619 provided from the user subscribed mobile network operator.

In FIG. 6, the UE 602 may use the ATSSS functionality using various combinations of wireless networks. Accordingly, the network may set a URSP rule suitable for each UE based on SIM information about each UE, subscribed mobile network operator information, available wireless network information, and the like, and may provision the URSP rule to the UE 602.

To transmit modem information, SIM information, subscribed mobile network operator information, or the like of the UE 602 to the network, the following information may be transmitted when the UE 602 registers with the network.
UE Radio Modem/SIM/MNO (mobile network operator) Information
SSDA (single SIM dual active)
   (3GPP) Multimode Support
      3GPP MODEM I: 5G NR, EUTRA, UTRA-FDD etc.
      3GPP MODEM II: 5G NR, EUTRA, UTRA-FDD etc.
   Non-3GPP Radio Support
      Wi-Fi, Bluetooth etc.
   Subscribed MNO
      PLMN/(S)NPN A
SSDS (single SIM dual standby)
   (3GPP) Multimode Support
      3GPP MODEM I: 5G NR, EUTRA, UTRA-FDD etc.
   Non-3GPP Radio Support
      Wi-Fi, Bluetooth etc.
   Subscribed MNO
      PLMN/(S)NPN A
DSDA (dual SIM dual active)
   (3GPP) Multimode Support
      3GPP MODEM I: 5G NR, EUTRA, UTRA-FDD etc.
3GPP MODEM II: 5G NR, EUTRA, UTRA-FDD etc.
   Non-3GPP Radio Support
      Wi-Fi, Bluetooth etc.
   Subscribed MNO
      PLMN/(S)NPN A
      PLMN/(S)NPN B
DSDS (dual SIM dual standby)
   (3GPP) Multimode Support
      3GPP MODEM I: 5G NR, EUTRA, UTRA-FDD etc.
   Non-3GPP Radio Support
      Wi-Fi, Bluetooth etc.
   Subscribed MNO
      PLMN/(S)NPN A
      PLMN/(S)NPN B
DSSS (dual SIM single standby)
   (3GPP) Multimode Support
      3GPP MODEM I: 5G NR, EUTRA, UTRA-FDD etc.
   Non-3GPP Radio Support
      Wi-Fi, Bluetooth etc.
   Subscribed MNO
      PLMN/(S)NPN A

When registering its UE radio modem/SIM/MNO information, the UE may transmit the information to the network. The UE may also transmit additional information other than the above information for information related to the wireless modem, the SIM, and the subscribed mobile network operator of the UE.

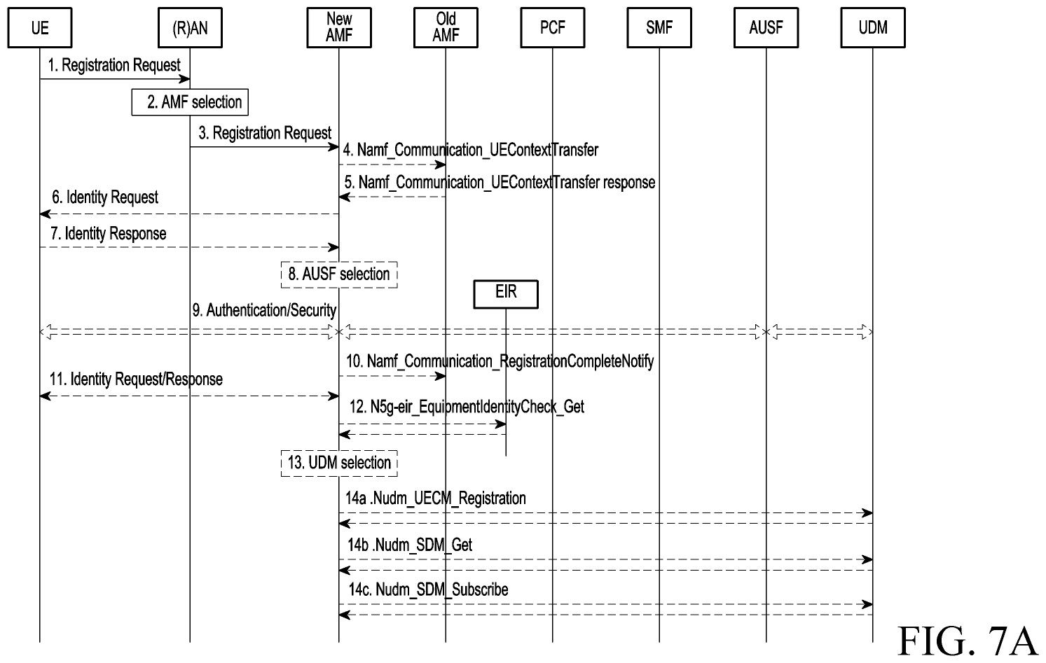

FIGS. 7A, 7B, and 7C illustrate a procedure in which a UE registers with a network according to an embodiment.

Referring to FIGS. 7A, 7B, and 7C, the steps omitting the description of the disclosure follow a general UE network registration procedure.

Referring to FIG. 7A, in step 1, the UE may include the UE radio modem/SIM/MNO information described with reference to FIG. 6 in a registration request message and transmit the information to the network.

In step 16 in FIG. 7B or step 21b in FIG. 7C, the AMF may transmit UE radio modem/SIM/MNO information transmitted by the UE to the PCF.

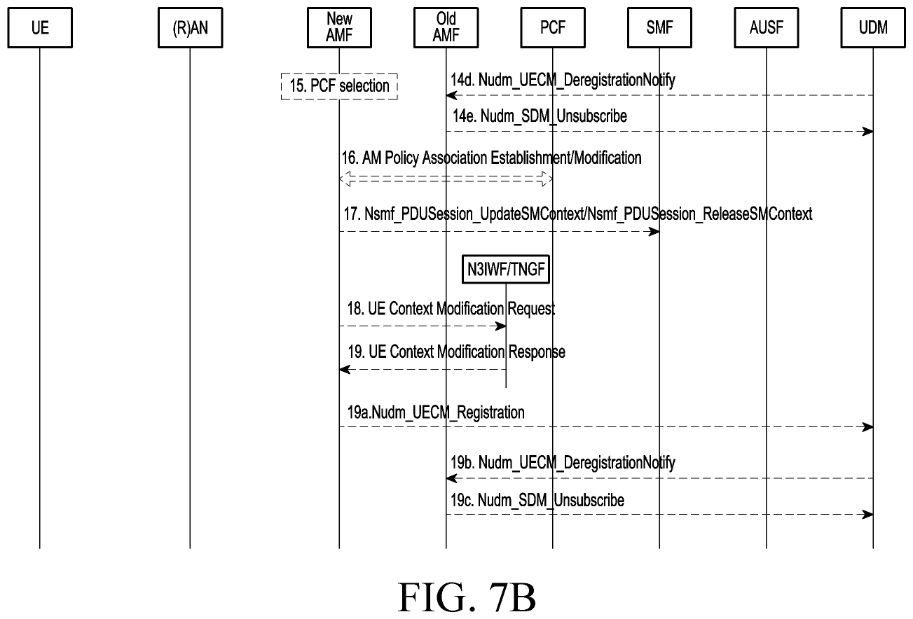

FIG. 8 illustrates a UE configuration update procedure 800 of a PCF according to an embodiment.

Referring to FIG. 8, the steps omitting the description of the disclosure follow a general PCF UE configuration update procedure.

In step 0, the PCF may update the UE policy (i.e., the URSP rule) based on at least one of the UE radio modem/SIM/MNO information received through the AMF and the UE subscription information received from the UDM. The PCF may refer to at least one of available UE-related information other than RAT types, access types, SIM types, other PLMN subscription information, and UE subscription information about the HPLMN.

In steps 1 to 3, the PCF may transmit the updated URSP rule to the UE.

Table 4 below shows examples of UE subscription information stored in the UDM.

TABLE 4

| Subscription data type | Field | Description |
|---|---|---|
| Access and Mobility | GPSI List | List of the GPSI (Generic Public Subscription |
| Subscription data | | Identifier) used both inside and outside of the |
| (data needed for UE | | 3GPP system to address a 3GPP subscription (see |
| Registration and | | NOTE 9). |
| Mobility | Internal Group | List of the subscribed internal group(s) that the |
| Management) | ID-list | UE belongs to. |
| | Subscribed UE- | The maximum aggregated uplink and downlink |
| | AMBR | MBRs to be shared across all Non-GBR QoS |
| | | Flows according to the subscription of the user. |
| | Subscribed UE- | List of maximum aggregated uplink and |
| | Slice-MBR(s) | downlink MBRs to be shared across all GBR and |
| | | Non-GBR QoS Flows related to the same S- |
| | | NSSAI according to the subscription of the user. |
| | | There is a single uplink and a single downlink |
| | | value per S-NSSAI. |
| | Subscribed S- | The Network Slices that the UE subscribes to. In |
| | NSSAIs | the roaming case, it indicates the subscribed |
| | | Network Slices applicable to the Serving PLMN |
| | | (NOTE 11). |
| | | For a subscribed S-NSSAI subject to NSAC for |
| | | the registered number of UE, the applicable |
| | | NSAC admission mode is included as described |
| | | in clause 4.2.11.5.2. |
| | Default S-NSSAIs | The Subscribed S-NSSAIs marked as default S- |
| | | NSSAI. In the roaming case, only those |
| | | applicable to the Serving PLMN (NOTE 12). |
| | Other PLMNs | List of other PLMN/SNPS(s) subscribed. |
| | Data | |
| | Subscription | Subscription Grade for ATSSS via VPLMN or |
| | Grade | other 3GPP Accesses |

The UE subscription information may include at least one of fields of other PLMNs data and subscription grade. The field of other PLMNs data may include information about the PLMN other than the HPLMN to which the UE subscribes.

The field of subscription grade may include a value indicating a grade at which the UE may use the ATSSS service. The value indicating the grade may include platinum, gold, silver, bronze, and the like, which indicates that the ATSSS service provided may be different depending on the grade.

Table 5 below shows an example of an extended URSP rule for an ATSSS service.

TABLE 5

| | | | PCF | |
|---|---|---|---|---|
| | | | permitted | |
| | | | to modify | |
| | | | in | |
| Information name | Description | Category | URSP | Scope |
| Route Selection | Determines the order in which the | Mandatory | Yes | UE |
| Descriptor | Route Selection Descriptors are to be | (NOTE 1) | | context |
| Precedence | applied. | | | |
| Route selection | This part defines the route selection | Mandatory | | |
| components | components | (NOTE 2) | | |
| SSC Mode | One single value of SSC | Optional | Yes | UE |
| Selection | mode. (NOTE 5) | | | context |
| Network Slice | Either a single value or a list of values | Optional(NOTE 3) | Yes | UE |
| Selection | of S-NSSAI(s). | | | context |
| DNN Selection | Either a single value or a list of values | Optional | Yes | UE |
| | of DNN(s). | | | context |
| PDU Session Type | One single value of PDU Session | Conditional | Yes | UE |
| Selection | Type | (NOTE 8) | | context |
| Non-Seamless | Indicates if the traffic of the matching | Optional(NOTE 4) | Yes | UE |
| Offload indication | application is to be offloaded to non- | | | context |
| | 3GPP access outside of a PDU | | | |
| | Session. | | | |
| ProSe Layer-3 UE- | Indicates if the traffic of the matching | Optional | Yes | UE |
| to-Network Relay | application is to be sent via a ProSe | (NOTE 4) | | context |
| Offload indication | Layer-3 UE-to-Network Relay outside | | | |
| | of a PDU session. | | | |
| ATSSS Mode | Preference of ATSSS Mode for MA | Mandatory | | |
| Selection | PDU Session | | | |
| Components | | | | |

The UE subscription information may include an ATSSS mode selection component.

Table 6, Table 7, Table 8 and Table 9 below show ATSSS mode selection components. As an embodiment, the ATSSS mode selection components may include an available RAT type, an available access type, an available SIM type, available other available PLMN subscription information, and subscription information for the HPLMN.

TABLE 6

| | | | | Access | |
|---|---|---|---|---|---|
| PLMN/ | Equivalent/ | | 3GPP | Type | RAT Type |
| SNPN | Roaming | SIM | MODEM | preference | preference |
| Single | NONE | Single/ | Single | 3 GPP | 15G |
| | | Dual | | | NR/EUTRA/ |
| | | | | | UTRA-FDD |
| | | | | Non-3GPP | |
| | | | | Multi- | |
| | | | | Access | |
| | | | Dual | 3GPP | 5G |
| | | | | | NR/EUTRA/ |
| | | | | | UTRA-FDD |
| | | | | Non-3GPP | |
| | | | | Multi- | |
| | | | | Access | |
| | | | | Multi- | 5G |
| | | | | Access | NR/EUTRA/ |
| | | | | (3GPP) | UTRA-FDD |
| | | | | | 5G |
| | | | | | NR/EUTRA/ |
| | | | | | UTRA-FDD |

TABLE 7

| | Equivalent/ | | 3GPP | PLMN | Access Type | RAT Type |
|---|---|---|---|---|---|---|
| PLMN/SNPN | Roaming | SIM | MODEM | Type | preference | preference |
| Multiple | No | Single | Single | HPLMN | 3GPP | 5G |
| | | | | | | NR/EUTRA/UTRA- |
| | | | | | | FDD |
| | | | | | Non-3GPP | |
| | | | | | Multi- | |
| | | | | | Access | |
| | | | Dual | | 3GPP | 5G |
| | | | | | | NR/EUTRA/UTRA- |
| | | | | | | FDD |
| | | | | | Non-3GPP | |
| | | | | | Multi- | |
| | | | | | Access | |
| | | | | | Multi- | 5G |
| | | | | | Access | NR/EUTRA/UTRA- |
| | | | | | (3GPP) | FDD |
| | | | | | | 5G |
| | | | | | | NR/EUTRA/UTRA- |
| | | | | | | FDD |

TABLE 8

| | Equivalent/ | | 3GPP | | Access Type | RAT Type |
|---|---|---|---|---|---|---|
| PLMN/SNPN | Roaming | SIM | MODEM | PLMN Type | preference | preference |
| Multiple | No | Dual | Single | PLMN1 OR | 3GPP | 5G |
| | | | | PLMN2 | | NR/EUTRA/UTRA- |
| | | | | (In case of | | FDD |
| | | | | DSDS and | Non-3GPP | |
| | | | | both | Multi- | |
| | | | | subscriptions | Access | |
| | | | | available) | | |
| | | | Dual | PLMN1 OR | 3GPP | 5G |
| | | | | PLMN2 | | NR/EUTRA/UTRA- |
| | | | | (In case of | | FDD |
| | | | | both | Non-3GPP | |
| | | | | subscriptions | Multi- | |
| | | | | available) | Access | |
| | | | | PLMN1 AND | Multi- | 5G |
| | | | | PLMN2 | Access | NR/EUTRA/UTRA- |
| | | | | (In case of | (3GPP) | FDD |
| | | | | both | | 5G |
| | | | | subscriptions | | NR/EUTRA/UTRA- |
| | | | | available) | | FDD |

TABLE 9

| | Equivalent/ | | 3GPP | PLMN | Access Type | RAT Type |
|---|---|---|---|---|---|---|
| PLMN/SNPN | Roaming | SIM | MODEM | Type | preference | preference |
| Multiple | Yes | Dual | Single | PLMN1 OR | 3GPP | 5G |
| | | | | PLMN2 | | NR/EUTRA/UTRA- |
| | | | | (In case of | | FDD |
| | | | | DSDS) | Non-3GPP | |
| | | | | | Multi-Access | |
| | | | Dual | PLMN1 OR | 3GPP | 5G |
| | | | | PLMN2 | | NR/EUTRA/UTRA- |
| | | | | | | FDD |
| | | | | | Non-3GPP | |
| | | | | | Multi-Access | |
| | | | | PLMN1 | Multi-Access | 5G |
| | | | | AND | (3GPP) | NR/EUTRA/UTRA- |
| | | | | PLMN2 | | FDD |
| | | | | | | 5G |
| | | | | | | NR/EUTRA/UTRA- |
| | | | | | | FDD |

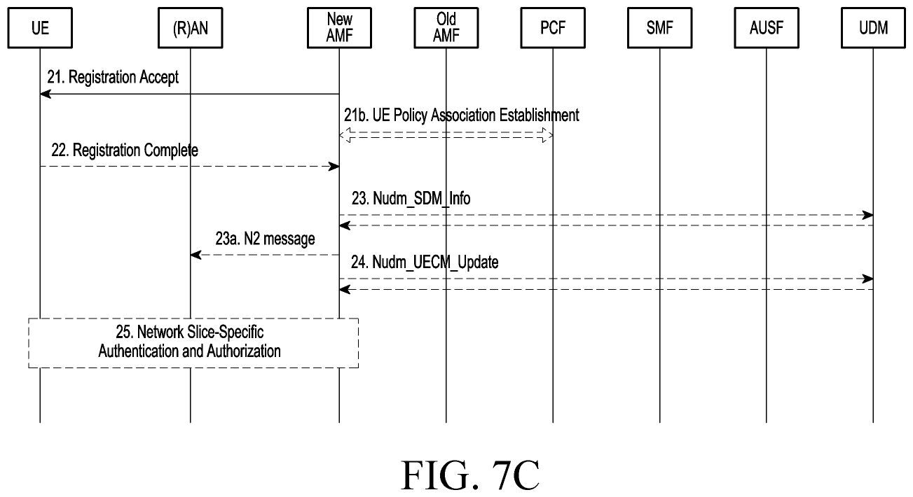

FIG. 9 illustrates a method 900 of a PCF entity according to an embodiment.

Referring to FIG. 9, in step 910, the PCF entity may receive, from a UE, radio capability information about the UE through an AMF entity. The PCF entity may receive information about the UE's wireless network use capability through the AMF from the UE. In step 920, the PCF entity may update URSP rule information based on the radio capability information about the UE. The PCF entity may update URSP rule information based on the information about the UE's wireless network use capability.

In step 930, the PCF entity may transmit, to the UE, the updated URSP rule information through the AMF entity. The PCF entity may transmit the updated URSP rule information to the UE through the AMF entity. The URSP rule information may include selection information about an ATSSS mode for a multiple access PDU session of the UE.

The wireless network use capability of the UE may include at least one of information about the SIM usable by the UE, information about the modem, and information about the mobile network operator, and the information about the SIM and the information about the MODEM may include information about dual use.

The selection information about the ATSSS mode for the multiple access PDU session of the UE may include information about at least one of the SIM type, the access type, and the RAT type for the multiple access PDU session, and the information about the SIM type may include information about dual use.

The information about the access type may include information about the communication type related to 3GPP and non-3GPP, and the information about the RAT type may include information indicating that the plurality of RAT types related to the 3GPP are simultaneously used.

The PCF entity may receive UE subscriber information from the UDM entity, the URSP rule information may be updated based on at least one of information about the UE's wireless network use capability and the UE subscriber information, and the UE subscriber information may include at least one of other PLMN subscription information about the UE and information about the subscription grade when the UE selects the ATSSS mode.

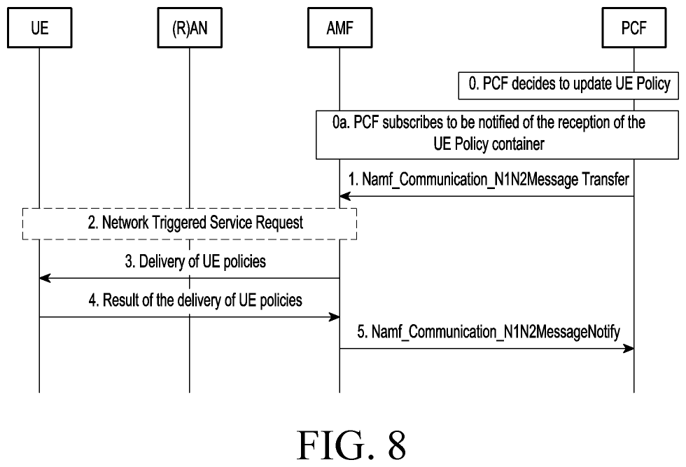

FIG. 10 illustrates a method 1000 of a UE according to an embodiment.

Referring to FIG. 10, in step 1010, the UE may transmit, to a PCF entity, radio capability information about the UE through an AMF entity. The UE may transmit information about the wireless network use capability of the UE to the PCF entity through the AMF entity. In step 1020, the UE may receive, from the PCF entity, updated URSP rule information through the AMF entity. The UE may receive updated URSP rule information from the PCF entity through the AMF entity. The information about the wireless network use capability of the UE may be used to update the URSP rule information, and the URSP rule information may include ATSSS mode selection information for the multiple access PDU session of the UE.

The wireless network use capability of the UE may include at least one of information about the SIM usable by the UE, information about the modem, and information about the mobile network operator, and the information about the SIM and the information about the MODEM may include information about dual use.

The selection information about the ATSSS mode for the multiple access PDU session of the UE may include information about the SIM type, the access type, and the RAT type for the multiple access PDU session, and the information about the SIM type may include information about dual use.

The information about the access type may include information about the communication type related to 3GPP and non-3GPP, and the information about the RAT type may include information indicating that the plurality of RAT types related to the 3GPP are simultaneously used.

The URSP rule information is updated based on the information about the wireless network use capability of the UE and the UE subscriber information stored in a UDM entity.

The UE subscriber information may include at least one of the UE's pre-subscription information, other PLMN subscription information about the UE and information about a subscription grade when the UE selects the ATSSS mode.

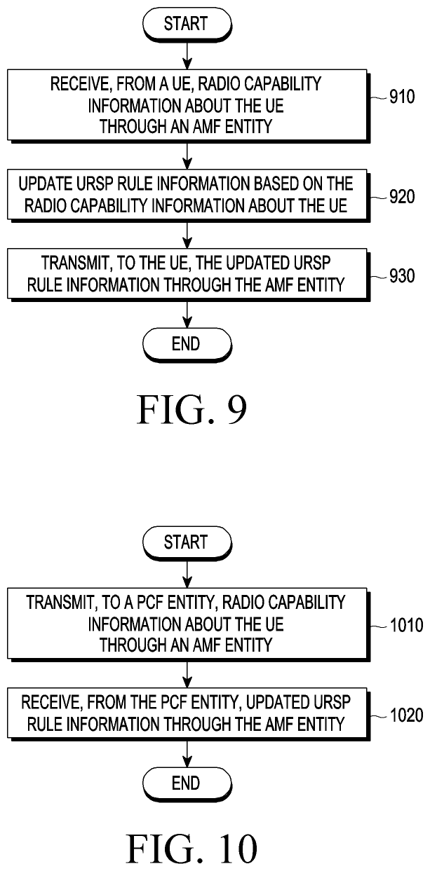

FIG. 11 illustrates a configuration of a base station or a network entity according to an embodiment.

Referring to FIG. 11, the network entity may include a processor 1120 controlling the overall operation of the network entity, a transceiver 1100 including a transmitter and a receiver, and memory 1110. Without limited thereto, the network entity may include fewer or more components than those shown in FIG. 11.

The transceiver 1100 may transmit/receive signals to/from at least one of other network entities or a UE. The signals transmitted/received with at least one of the other network entities or the UE may include control information and data.

The processor 1120 may control the network entity to perform any one of the above-described embodiments. The processor 1120, the memory 1110, and the transceiver 1100 are not necessarily implemented in separate modules but rather as a single component, e.g., a single chip. The processor 1120 and the transceiver 1100 may be electrically connected with each other. The processor 1120 may be an application processor (AP), a communication processor (CP), a circuit, an application-specific circuit, or at least one processor.

The memory 1110 may store a default program for operating the network entity, application programs, and data, such as configuration information. The memory 1110 provides the stored data according to a request of the processor 1120. The memory 1110 may include a storage medium, such as read only memory (ROM), random access memory (RAM), a hard disk, a compact disc (CD)-ROM, a digital versatile disc (DVD), or a combination of storage media. There may be provided a plurality of memories 1110. The processor 1120 may perform the above-described embodiments based on a program for performing the above-described embodiments stored in the memory 1110.

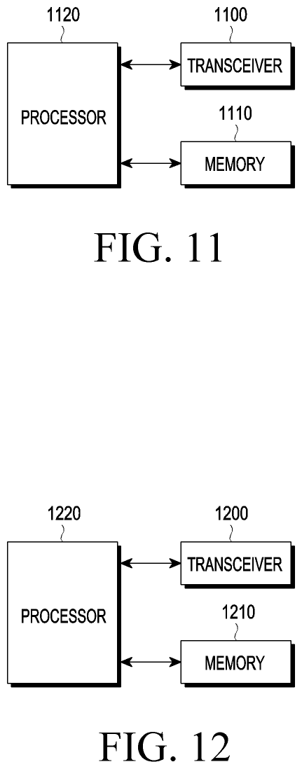

FIG. 12 illustrates a configuration of a UE according to an embodiment. Referring to FIG. 12, a UE may include a processor 1220 controlling the overall operation of the UE, a transceiver 1200 including a transmitter and a receiver, and memory 1210. The UE may include fewer or more components than those shown in FIG. 12.

The transceiver 1200 may transmit/receive signals to/from network entities or other UEs. The signals transmitted/received with the network entity may include control information and data. The transceiver 1200 may receive signals via a radio channel, output the signals to the processor 1220, and transmit signals output from the processor 1220 via a radio channel.

The processor 1220 may control the UE to perform any one of the above-described embodiments. The processor 1220, the memory 1210, and the transceiver 1200 are not necessarily implemented in separate modules but rather as a single component, e.g., a single chip. The processor 1220 and the transceiver 1200 may be electrically connected with each other. The processor 1220 may be an AP, a CP, a circuit, an application-specific circuit, or at least one processor.

The memory 1210 may store a default program for operating the UE, application programs, and data, such as configuration information. The memory 1210 provides the stored data according to a request of the processor 1220. The memory 1210 may include a storage medium, such as ROM, RAM, hard disk, CD-ROM, DVD, or a combination of storage media. There may be provided a plurality of memories 1210. The processor 1220 may perform the above-described embodiments based on a program for performing the above-described embodiments stored in the memory 1210.

It should be noted that the above-described configuration views, example views of control/data signal transmission methods, example views of operational procedures, and configuration views are not intended to limit the scope of the disclosure. The disclosure may be implemented with fewer components without departing from the scope of the disclosure. The embodiments may be practiced in combination, as necessary. For example, some of the methods disclosed herein may be combined to operate the network entity and the UE.

The above-described operations of the base station or UE may be realized by equipping a memory device retaining their corresponding codes in the base station device or any component of the UE. That is, the controller in the base station or the UE may execute the above-described operations by reading and executing the program codes stored in the memory device by a processor or central processing unit (CPU).

As described herein, various components or modules in the entity, base station or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described herein.

The programs (software modules or software) may be stored in random access memories, non-volatile memories including flash memories, ROMs, electrically erasable programmable ROMs (EEPROMs), magnetic disc storage devices, CD-ROMs, DVDs, or other types of optical storage devices, or magnetic cassettes. Alternatively, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

It should be appreciated that the blocks in each flowchart and combinations of the flowcharts herein may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method by a policy control function (PCF) entity in a wireless communication system, the method comprising:
receiving, from a user equipment (UE), a registration request including radio capability information about the UE through an access and mobility management function (AMF) entity;
updating UE route selection policy (URSP) rule information based on the radio capability information about the UE; and
transmitting, to the UE, the updated URSP rule information through the AMF entity.

2. The method of claim 1,
wherein the radio capability information about the UE includes information about supporting steering and switching across multiple access packet data unit (PDU) sessions of the UE, and
wherein the URSP rule information includes access type preference information indicating the multiple access PDU sessions of the UE.

3. The method of claim 1,
wherein the radio capability information about the UE includes at least one of information about at least one subscriber identity module (SIM) usable by the UE, information about at least one modem usable by the UE, and information about at least one mobile network operator usable by the UE, and
wherein at least one of the information about the at least one SIM, the information about the at least one modem, and the information about the at least one mobile network operator usable include information about dual use.

4. The method of claim 2, wherein the access type preference information includes at least one of information about at least one access type, and information about at least one radio access technology (RAT) type.

5. The method of claim 4, wherein the information about the at least one access type includes information about a communication type related to third generation partnership project (3GPP), and
wherein the information about the at least one RAT type includes information indicating that a plurality of RAT types related to the 3GPP are simultaneously used.

6. The method of claim 1, further comprising:
receiving, from a unified data management (UDM) entity, UE subscriber information,
wherein the URSP rule information is updated based on the radio capability information about the UE and the UE subscriber information, and
wherein the UE subscriber information includes at least one of other public land mobile network (PLMN) subscription information about the UE and information about a UE subscription grade related to the ATSSS mode.

7. A method by a user equipment (UE) in a wireless communication system, the method comprising:
transmitting, to a policy control function (PCF) entity, a registration request including radio capability information about the UE through an access and mobility management function (AMF) entity; and
receiving, from the PCF entity, updated UE route selection policy (URSP) rule information through the AMF entity,
wherein the radio capability information about the UE is used for the updated URSP rule information.

8. The method of claim 7,
wherein the radio capability information about the UE includes information about supporting steering and switching across multiple access packet data unit (PDU) sessions of the UE, and
wherein the URSP rule information includes access type preference information indicating the multiple access PDU sessions of the UE.

9. The method of claim 7,
wherein the radio capability information about the UE includes at least one of information about at least one subscriber identity module (SIM) usable by the UE, information about at least one modem usable by the UE, and information about at least one mobile network operator usable by the UE, and
wherein at least one of the information about the at least one SIM, the information about the at least one modem, and the information about the at least one mobile network operator usable include information about dual use.

10. The method of claim 8, wherein the access type preference information includes at least one of information about at least one access type, and information about at least one radio access technology (RAT) type.

11. A policy control function (PCF) entity in a wireless communication system, the PCF entity comprising:
a transceiver; and
at least one processor coupled to the transceiver and configured to:
receive, from a user equipment (UE), a registration request including radio capability information about the UE through an access and mobility management function (AMF) entity,
update UE route selection policy (URSP) rule information based on the radio capability information about the UE, and
transmit, to the UE, the updated URSP rule information through the AMF entity.

12. The PCF entity of claim 11,
wherein the radio capability information about the UE includes information about supporting steering and switching across multiple access packet data unit (PDU) sessions of the UE, and
wherein the URSP rule information includes access type preference information indicating the multiple access PDU sessions of the UE.

13. The PCF entity of claim 11,
wherein the radio capability information about the UE includes at least one of information about at least one subscriber identity module (SIM) usable by the UE, information about at least one modem usable by the UE, and information about at least one mobile network operator usable by the UE, and
wherein at least one of the information about the at least one SIM, the information about the at least one modem, and the information about the at least one mobile network operator usable include information about dual use.

14. The PCF entity of claim 12, wherein the access type preference information includes at least one of information about at least one access type, and information about at least one radio access technology (RAT) type.

15. The PCF entity of claim 14, wherein the information about the at least one access type includes information about a communication type related to third generation partnership project (3GPP), and
wherein the information about the at least one RAT type includes information indicating that a plurality of RAT types related to the 3GPP are simultaneously used.

16. The PCF entity of claim 11, wherein the at least one processor is further configured to:
receive, from a unified data management (UDM) entity, UE subscriber information,
wherein the URSP rule information is updated based on the radio capability information about the UE and the UE subscriber information, and
wherein the UE subscriber information includes at least one of other public land mobile network (PLMN) subscription information about the UE and information about a UE subscription grade related to the ATSSS mode.

17. A user equipment (UE) in a wireless communication system, the UE comprising:
a transceiver; and
at least one processor coupled to the transceiver and configured to:
transmit, to a policy control function (PCF) entity, a registration request including radio capability information about the UE through an access and mobility management function (AMF) entity, and
receive, from the PCF entity, updated UE route selection policy (URSP) rule information through the AMF entity,
wherein the radio capability information about the UE is used for the updated URSP rule information.

18. The UE of claim 17,
wherein the radio capability information about the UE includes information about supporting steering and switching across multiple access packet data unit (PDU) sessions of the UE, and
wherein the URSP rule information includes access type preference information indicating the multiple access PDU sessions of the UE.

19. The UE of claim 17,
wherein the radio capability information about the UE includes at least one of information about at least one subscriber identity module (SIM) usable by the UE, information about at least one modem usable by the UE, and information about at least one mobile network operator usable by the UE, and
wherein at least one of the information about the at least one SIM, the information about the at least one modem, and the information about the at least one mobile network operator usable include information about dual use.

20. The UE of claim 18, wherein the access type preference information includes at least one of information about at least one access type, and information about at least one radio access technology (RAT) type.
